(19) United States
(12) Patent Application Publication
(10) Pub. No.: US 2020/0042922 A1
(43) Pub. Date: Feb. 6, 2020

(54) DISPLAY SYSTEM FOR MONEY PROCESSOR

(71) Applicant: FUJI ELECTRIC CO., LTD., Kawasaki-shi (JP)

(72) Inventors: Nobuyuki NIIZUMA, Yokkaichi-city (JP); Yoshihiro NAKAMURA, Yokkaichi-city (JP)

(73) Assignee: FUJI ELECTRIC CO., LTD., Kawasaki-shi (JP)

(21) Appl. No.: 16/527,191

(22) Filed: Jul. 31, 2019

(30) Foreign Application Priority Data
Aug. 2, 2018 (JP) 2018-145722

(51) Int. Cl. G06Q 10/06; G06F 3/14; G06Q 10/00

(52) U.S. Cl. CPC G06Q 10/06316; G06Q 10/20; G06F 3/14

(57) ABSTRACT

A display system for a money processor configured to deposit and withdraw money. The display system includes a display coupled to the money processor, and a memory configured to store a plurality of pieces of maintenance step data respectively corresponding to maintenance operations of the components of the money processor, each piece of maintenance step data including a plurality of pieces of image data corresponding to a series of steps of the corresponding maintenance operation. The display system also includes a controller that displays a piece of image data on the display, to show a situation of the money processor that an operator sees at the step corresponding thereto. The controller is configured to, upon determining that one of the components needs maintenance, read a corresponding piece of the maintenance step data from the memory, and display the pieces of image data included in the maintenance operation data sequentially on the display.

The present application claims priority to and incorporates by reference the entire contents of Japanese Patent Application No. 2018-145722 filed in Japan on Aug. 2, 2018.

### BACKGROUND

The present disclosure relates to a display system for a money processor, more specifically, relates to a display system for a money processor, for example, that guides maintenance operation steps for components in a money processor connected to a point of sales (POS) register device in stores such as a supermarket.

For example, in stores such as a supermarket, a convenience store, etc., there have been known money processors such as an automatic change machine connected to a point of sales (POS) terminal. These kinds of money processors generally withdraw, while depositing and storing paper money and coins received from customers in a storage, changes from the storage by withdrawal instructions.

When an error occurs in such a money processor, a display system for a money processor is developed that sequentially displays, on a display unit of a POS register device, an error release operation for returning from an error state occurring in the money processor to a normal state as image data depending on a progress situation of the error release operation (for example, see Japanese Patent No. 5239384).

There is a cause for occurrence of an error in a money processor, and the error may reoccur unless the cause is removed. Examples of the cause for the occurrence of this error include not only device failure but also wear and tear or dirt on repeatedly used components and mixing of foreign matter. Specifically, when an error of coin jamming occurs in a money processor, removing jammed coins is defined as an error release operation. However, a possible cause of coin jamming is contamination or the like of a conveyance path for conveying coins. Unless the conveyance path is cleaned, the error of coin jamming repeatedly occurs.

The display system for a money processor described above is useful for improving operability and convenience of error release when an error occurs in a money processor, but the display system just presents an error release operation when an error occurs, and is not able to reduce the occurrence of future error.

In view of the foregoing, the present disclosure provides a display system for a money processor capable of reducing the occurrence of future errors.

### SUMMARY

In some embodiments, in a display system for a money processor, the display system includes: a display that is electrically connected to a money processor configured to deposit and withdraw money, the display being configured to display predetermined information; a memory configured to store an image data indicating a series of steps for a predetermined operation; and a controller configured to display the image data indicating the series of steps for the predetermined operation stored in the memory on the display, wherein the memory is configured to store maintenance step data that includes image data indicating each maintenance step of a maintenance operation for each component of the money processor, the image data is an image of a situation of the money processor that an operator sees at each stage during progress of the maintenance operation, and a plurality of the image data are prepared corresponding to each stage during progress of the maintenance operation, and the controller is configured to read, when determining that any of the components in the money processor requires the maintenance operation based on predetermined condition, the maintenance step data corresponding to the component that requires the maintenance operation from the memory, and display the image data corresponding to a progress situation of the maintenance operation performed by the operator sequentially on the display depending on the progress situation of the maintenance operation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram schematically illustrating the configuration of a display system for a money processor in accordance with an embodiment;

FIG. 2 is a flowchart illustrating processing contents of maintenance display processing performed by a control unit illustrated in FIG. 1;

FIG. 3 is an image view illustrating a step of a maintenance operation;

FIG. 4 is an image view illustrating a step of the maintenance operation;

FIG. 5 is an image view illustrating a step of the maintenance operation;

FIG. 6 is an image view illustrating a step of the maintenance operation;

FIG. 7 is an image view illustrating a step of the maintenance operation;

FIG. 8 is an image view illustrating a step of the maintenance operation;

FIG. 9 is an image view illustrating a step of the maintenance operation;

FIG. 10 is an image view illustrating a step of the maintenance operation;

FIG. 11 is an image view illustrating a step of the maintenance operation;

FIG. 12 is an image view illustrating a step of the maintenance operation;

FIG. 13 is an image view illustrating a step of the maintenance operation;

FIG. 14 is an image view illustrating a step of the maintenance operation;

FIG. 15 is an image view illustrating a step of the maintenance operation;

FIG. 16 is an image view illustrating a step of the maintenance operation; and

FIG. 17 is an image view illustrating a step of the maintenance operation.

### DETAILED DESCRIPTION

A preferred embodiment of a display system for a money processor according to the present disclosure will now be described in detail with reference to the accompanying drawings.

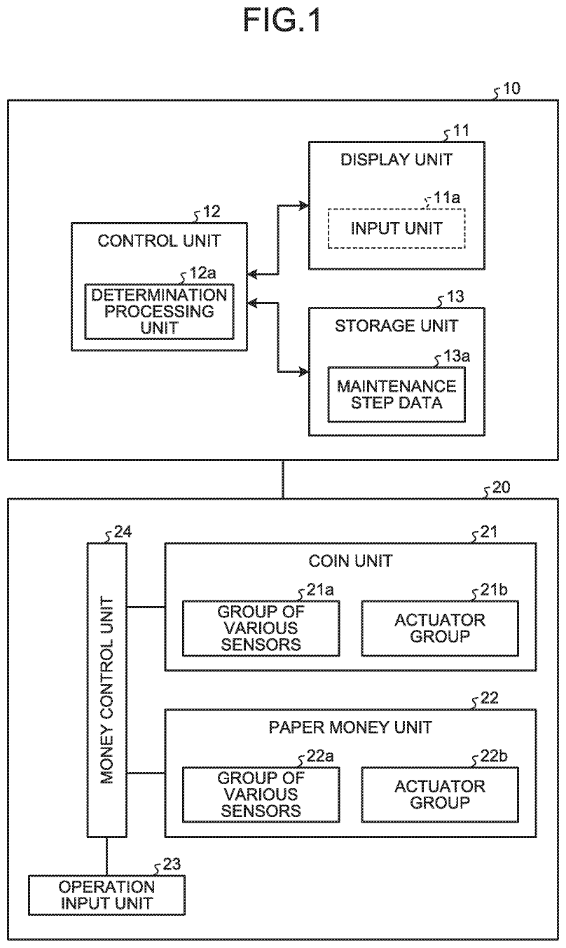

FIG. 1 is a block diagram schematically illustrating the configuration of a display system for a money processor in accordance with an embodiment. The display system for a money processor exemplified in the embodiment is formed of, for example, a point of sales (POS) register device 10 as a terminal device that collects and manages information at the time of performing a commercial transaction with a customer in stores such as a supermarket and a convenience store, and this POS register device 10 has an automatic change machine 20 as a money processor electrically connected thereto.

The automatic change machine 20 will be described. The automatic change machine 20 includes a coin unit 21, a paper money unit 22, an operation input unit 23, and a money control unit 24.

The coin unit 21 is a unit for depositing and withdrawing coins, and includes a group of various sensors 21a and an actuator group 21b. This coin unit 21 is a unit for supplying coins put through an unillustrated coin slot in a state where the coins are separated one by one and distinguishing the authenticity and denomination of the coins, and sorting and storing the coins (specie money) by denomination after feeding the coins. In addition, the coin unit 21 is a unit for discharging stored coins to an unillustrated coin withdrawal slot depending on a withdrawal command.

The paper money unit 22 is a unit for depositing and withdrawing paper money, and includes a group of various sensors 22a and an actuator group 22b. This paper money unit 22 is a unit for feeding paper money put through an unillustrated paper money slot, distinguishing the authenticity and denomination of the paper money in the middle of feeding the paper money, and sorting and storing the paper money determined to be specie money depending on the denomination. Paper money determined not to be specie money is returned to the paper money slot. When there is a withdrawal instruction, the paper money unit 22 is a unit for feeding stored paper money and withdrawing the paper money from an unillustrated paper money withdrawal slot.

The operation input unit 23 is formed of, for example, a numeric keypad and various kinds of buttons, and is a unit for performing an input operation. The money control unit 24 is a unit for integrally controlling the operation of the automatic change machine 20 by following a preliminarily stored computer program and data.

The POS register device 10 is a host device of the automatic change machine 20, is formed of a personal computer-based register in which data such as merchandise names, prices, and customer information is instantly input by reading a bar code through an unillustrated bar code reader (scanner), and includes a display unit 11 and a control unit 12.

The display unit 11 is, for example, a liquid crystal touch panel, and configured to display various kinds of information. The display unit 11 includes an input unit 11a for allowing an input operation such as a touch operation.

The control unit 12 is configured to integrally control the operation of the POS register device 10 by following a computer program and data stored in a storage unit 13. The control unit 12 may cause a processor, for example, a central processing unit (CPU) to execute a computer program, in other words, the control unit 12 may be implemented by software, by hardware such as an integrated circuit (IC), or by a combination of software and hardware.

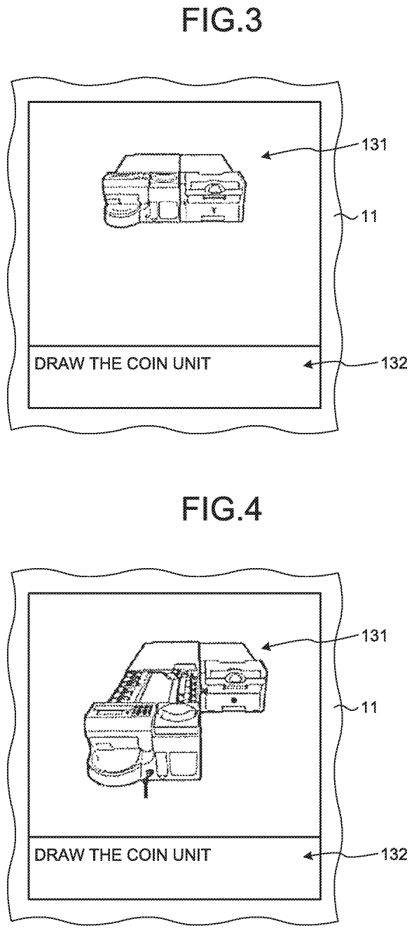

This kind of storage unit 13 stores therein maintenance step data 13a. The maintenance step data 13a is provided for each of the components that are the coin unit 21 and the paper money unit 22 forming the automatic change machine 20, and includes image data 131 (see FIG. 3) that indicates a maintenance operation of the corresponding component for each step and message data 132 (see FIG. 3) for each step. Examples of such a maintenance operation include a cleaning operation such as removal of dirt on the corresponding part and an exchange operation for exchanging the corresponding part, and the maintenance operation differs from an error release operation for returning from an error state to a normal state when an error occurs.

The control unit 12 includes a determination processing unit 12a. The determination processing unit 12a is a unit for determining whether each of the components that are the coin unit 21 and the paper money unit 22 in the automatic change machine 20 satisfies predetermined maintenance conditions. In the embodiment, the maintenance conditions differ depending on a target unit (component), and are, for example, use frequency and an elapsed time from previous replacement. The maintenance conditions are conditions of a degree in which an error can be prevented from occurring in the components.

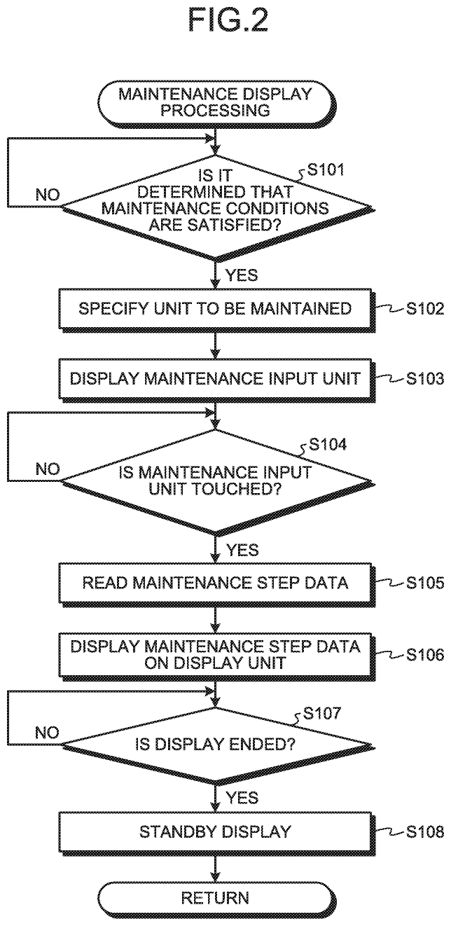

FIG. 2 is a flowchart illustrating processing contents of maintenance display processing performed by the control unit 12 illustrated in FIG. 1.

In this maintenance display processing, the control unit 12 determines, from an operating situation, an elapsed time, and the like of each of the components that are the coin unit 21 and the paper money unit 22 transmitted through the money control unit 24 in the automatic change machine 20, whether maintenance conditions are satisfied through the determination processing unit 12a (step S101). When determining that the maintenance conditions are not satisfied (No at step S101), the control unit 12 repeats the processing at step S101.

By contrast, when determining that the maintenance conditions are satisfied (Yes at step S101), the control unit 12 specifies a unit to be maintained, in other words, a component to be maintained (step S102).

The control unit 12 that specifies a unit to be maintained in this manner displays a maintenance input unit as the input unit 11a on the display unit 11 (step S103), and after that, waits for the maintenance input unit to be touched.

When a component that satisfies the maintenance conditions is specified in this manner, the control unit 12 does not prompt a maintenance operation immediately, but causes the maintenance input unit to be displayed on the display unit 11, thereby preventing loss of opportunities of commercial transactions in a store while informing a manager of the store serving as an operator of existence of a unit requiring the maintenance operation.

During this time, the control unit 12 determines whether the maintenance input unit is touched (step S104). When the maintenance input unit is not touched (No at step S104), the control unit 12 repeats the determination processing at step S104.

When the maintenance input unit is touched (Yes at step S104), the control unit 12 reads the maintenance step data 13a for a component serving as a unit to be maintained from the storage unit 13 (step S105), and sequentially displays the maintenance step data 13a on the display unit 11 (step S106).

The processing at step S106 will be described in detail. In the coin unit 21 of this embodiment, a coin inspection unit that distinguishes the authenticity and denomination of coins is defined as a unit to be maintained.

As illustrated in FIG. 3, the control unit 12 displays the image data 131 of the automatic change machine 20 serving as a first step and the message data 132 “Draw the coin unit” corresponding to the first step. After elapse of a prescribed time (for example, 30 seconds to 3 minutes) from the display of the first step, the control unit 12 displays the image data 131 of the automatic change machine 20 serving as a second step and the message data 132 “Draw the coin unit” corresponding to the second step as illustrated in FIG. 4.

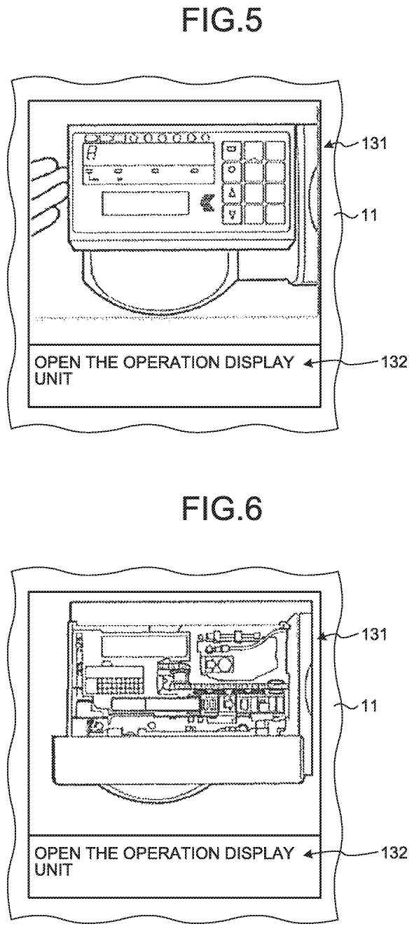

After elapse of a prescribed time from the display of the second step, the control unit 12 displays the image data 131 of the automatic change machine 20 serving as a third step and the message data 132 “Open the operation display unit” corresponding to the third step as illustrated in FIG. 5. After elapse of a prescribed time from the display of the third step, the control unit 12 displays the image data 131 of the automatic change machine 20 serving as a fourth step and the message data 132 “Open the operation display unit” corresponding to the fourth step as illustrated in FIG. 6.

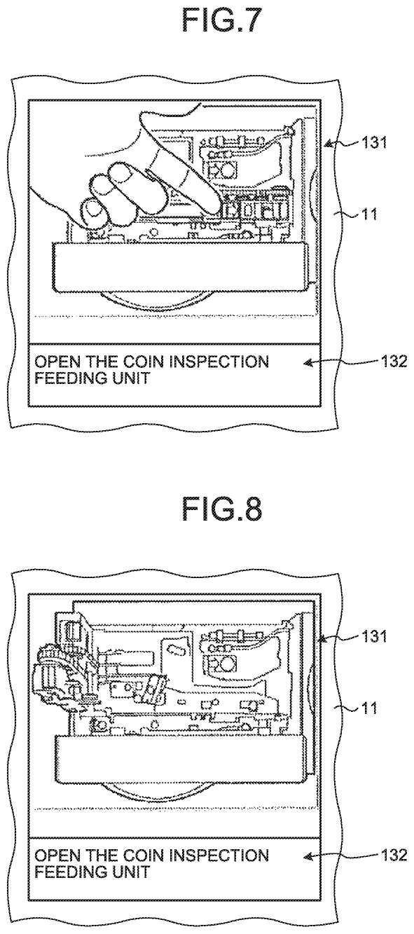

After elapse of a prescribed time from the display of the fourth step, the control unit 12 displays the image data 131 of the automatic change machine 20 serving as a fifth step and the message data 132 “Open the coin inspection feeding unit” corresponding to the fifth step as illustrated in FIG. 7. After elapse of a prescribed time from the display of the fifth step, the control unit 12 displays the image data 131 of the automatic change machine 20 serving as a sixth step and the message data 132 “Open the coin inspection feeding unit” corresponding to the sixth step as illustrated in FIG. 8.

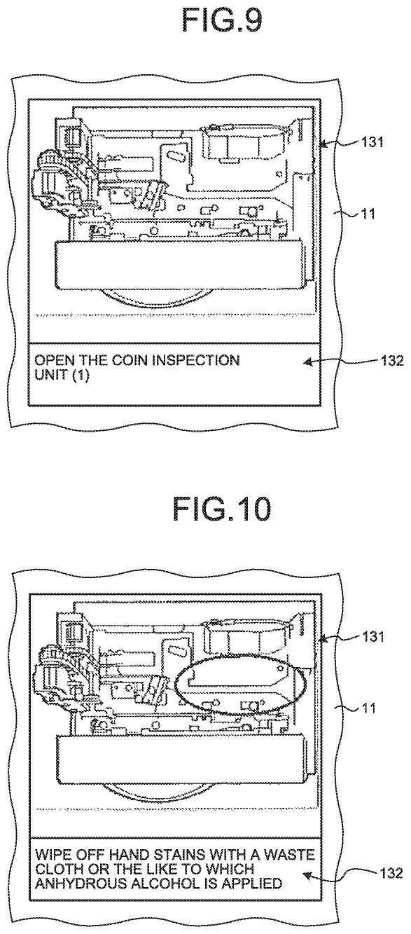

After elapse of a prescribed time from the display of the sixth step, the control unit 12 displays the image data 131 of the automatic change machine 20 serving as a seventh step and the message data 132 “Open the coin inspection unit (1)” corresponding to the seventh step as illustrated in FIG. 9. After elapse of a prescribed time from the display of the seventh step, the control unit 12 displays the image data 131 of the automatic change machine 20 serving as an eighth step and the message data 132 “Wipe off hand stains with a waste cloth or the like to which anhydrous alcohol is applied” corresponding to the eighth step as illustrated in FIG. 10.

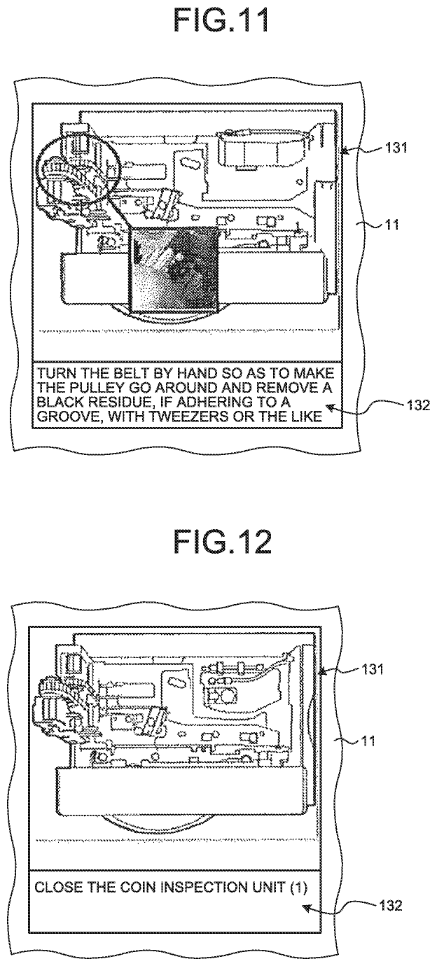

After elapse of a prescribed time from the display of the eighth step, the control unit 12 displays the image data 131 of the automatic change machine 20 serving as a ninth step and the message data 132 “Turn the belt by hand so as to make the pulley go around and remove a black residue, if adhering to a groove, with tweezers or the like” corresponding to the ninth step as illustrated in FIG. 11. After elapse of a prescribed time from the display of the ninth step, the control unit 12 displays the image data 131 of the automatic change machine 20 serving as a tenth step and the message data 132 “Close the coin inspection unit (1)” corresponding to the tenth step as illustrated in FIG. 12.

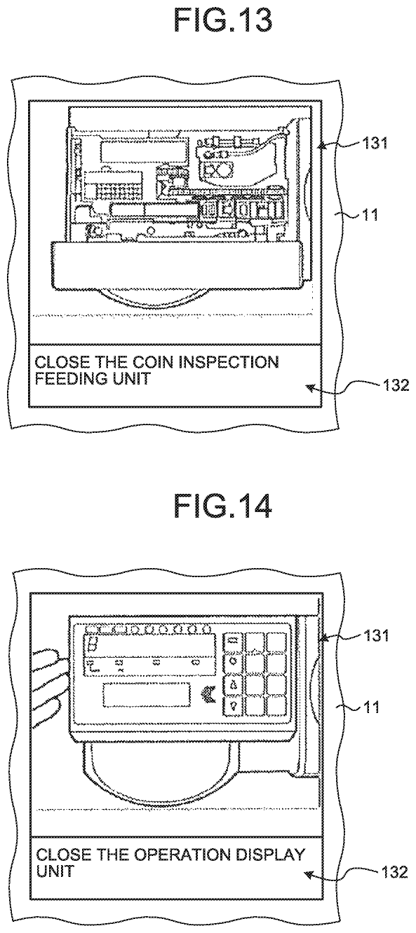

After elapse of a prescribed time from the display of the tenth step, the control unit 12 displays the image data 131 of the automatic change machine 20 serving as an eleventh step and the message data 132 “Close the coin inspection feeding unit” corresponding to the eleventh step as illustrated in FIG. 13. After elapse of a prescribed time from the display of the eleventh step, the control unit 12 displays the image data 131 of the automatic change machine 20 serving as a twelfth step and the message data 132 “Close the operation display unit” corresponding to the twelfth step as illustrated in FIG. 14.

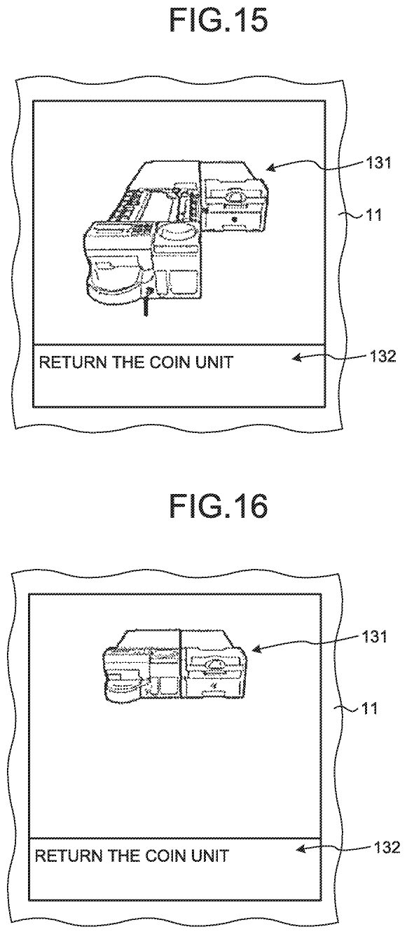

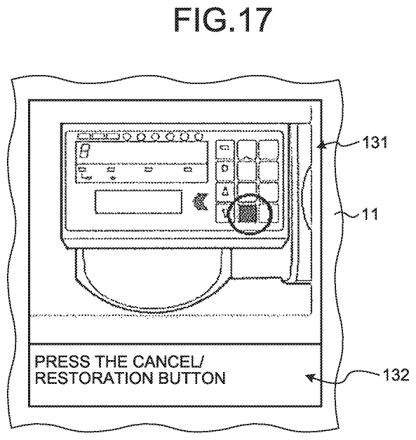

After elapse of a prescribed time from the display of the twelfth step, the control unit 12 displays the image data 131 of the automatic change machine 20 serving as a thirteenth step and the message data 132 “Return the coin unit” corresponding to the thirteenth step as illustrated in FIG. 15. After elapse of a prescribed time from the display of the thirteenth step, the control unit 12 displays the image data 131 of the automatic change machine 20 serving as a fourteenth step and the message data 132 “Return the coin unit” corresponding to the fourteenth step as illustrated in FIG. 16.

After elapse of a prescribed time from the display of the fourteenth step, the control unit 12 performs the processing at step S106 described above by displaying the image data 131 of the automatic change machine 20 serving as a fifteenth step and the message data 132 “Press the cancel/restoration button” corresponding to the fifteenth step as illustrated in FIG. 17.

By performing the processing at step S106 and determining whether the cancel/restoration button forming the operation input unit 23 is pressed down, the control unit 12 determines whether the display is ended (step S107).

When determining that the display is ended (Yes at step S107), the control unit 12 performs the standby display on the display unit 11 (step S108), and after that, returns the steps and ends the current processing.

As described above, according to the display system for a money processor of the present embodiment, when determining that any of the components in the automatic change machine 20 satisfies maintenance conditions through the determination processing unit 12a, the control unit 12 reads the maintenance step data 13a corresponding to the component from the storage unit 13 and sequentially displays the image data 131 corresponding to a progress situation of a maintenance operation performed by an operator on the display unit 11 depending on the progress situation of the maintenance operation. Thus, the control unit 12 enables an operator to perform a maintenance operation by following the display of the display unit 11, and can reduce the occurrence of future error.

As above, the preferable embodiment has been described, but it should be noted that the present disclosure is not limited to this embodiment and various changes can be made.

In the embodiment described above, the display system for a money processor is formed of the POS register device 10. However, in the present disclosure, the display means forming the display system for a money processor may be a portable information terminal such as a tablet that an operator carries.

In the embodiment described above, in the maintenance display processing, the control unit 12 determines whether components in the automatic change machine 20 satisfy maintenance conditions through the determination processing unit 12a. However, in the present disclosure, predetermined conditions may be used for determining that any of the components in a money processor requires a maintenance operation. In other words, when an error occurs in any of the components in a money processor, a maintenance operation different from an error release operation may be sequentially displayed on the display unit. In this manner, even when an error occurs, a maintenance operation is performed so as to prevent a similar error from being repeated and reduce the occurrence of future error.

When the occurrence of an error in any of the components is required in such a manner, a setting unit for setting whether an error release operation is displayed or a maintenance operation is displayed on the display unit may be provided.

According to the present disclosure, when the control unit determines that any of the components in a money processor requires a maintenance operation from predetermined conditions, the control unit reads maintenance step data corresponding to the component from a storage unit and sequentially displays image data corresponding to a progress situation of a maintenance operation performed by an operator on a display unit depending on the progress situation of the maintenance operation. Thus, the control unit enables an operator to perform a maintenance operation by following display of the display unit and can reduce the occurrence of future error.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display system for a money processor configured to deposit and withdraw money, the money processor including a plurality of components, the display system comprising:
a display that is coupled to the money processor;
a memory configured to store a plurality of pieces of maintenance step data respectively corresponding to a plurality of maintenance operations, each piece of maintenance step data including a plurality of pieces of image data, corresponding to a series of steps of the corresponding maintenance operation, for one of the plurality of components of the money processor; and
a controller configured to display each of the pieces of image data stored in the memory on the display, each displayed piece of image data showing a situation of the money processor that an operator sees at one of the series of steps corresponding thereto, wherein
the controller is configured to, upon determining that one of the plurality of components of the money processor requires maintenance based on a predetermined condition,
read one of the plurality of pieces of maintenance step data corresponding to the one component from the memory, and
display the plurality of pieces of image data included in the read maintenance operation step data sequentially on the display.

2. The display system for a money processor according to claim 1, wherein the maintenance operation includes an operation for removing a cause for occurrence of an error state in the money processor.

3. The display system for a money processor according to claim 2, wherein the display is integrated with a host device of the money processor or includes a portable information terminal electrically coupled to the money processor.

4. The display system for a money processor according to claim 1, wherein the display is integrated with a host device of the money processor or includes a portable information terminal electrically coupled to the money processor.
